(19) United States
(12) Patent Application Publication
(10) Pub. No.: US 2020/0051734 A1
(43) Pub. Date: Feb. 13, 2020

(54) COIL MODULE

(71) Applicant: WITS Co., Ltd., Yongin-si (KR)

(72) Inventors: Jae Sun WON, Suwon-si (KR); Hee Seung KIM, Suwon-si (KR); Soon Joung YIO, Suwon-si (KR); Dong Yeol LEE, Suwon-si (KR); Jae Hyuk JANG, Suwon-si (KR); Young Seung ROH, Suwon-si (KR)

(73) Assignee: WITS Co., Ltd., Yongin-si (KR)

(21) Appl. No.: 16/536,459

(22) Filed: Aug. 9, 2019

(30) Foreign Application Priority Data
Aug. 10, 2018 (KR) 10-2018-0093658

(51) Int. Cl. H01F 27/28; H01F 27/32; H02J 50/10

(52) U.S. Cl. CPC H01F 27/2876; H01F 27/32; H02J 50/10; H01F 27/2885; H01F 27/2804

(57) ABSTRACT

A coil module includes an insulation layer; a wireless power transfer (WPT) coil disposed on a first surface of the insulation layer; and a heat dissipation pattern disposed around the WPT coil on the first surface of the insulation layer or disposed on a second surface of the insulation layer opposite the first surface, wherein a width the heat dissipation pattern is narrower than a width of the WPT coil.

### CROSS-REFERENCE TO RELATED APPLICATION

This application claims the benefit under 35 U.S.C. § 119(a) of Korean Patent Application No. 10-2018-0093658 filed on Aug. 10, 2018 in the Korean Intellectual Property Office, the entire disclosure of which is incorporated herein by reference for all purposes.

### BACKGROUND

### 1. Field

The following description relates to a coil module.

### 2. Description of Background

Many mobile communications companies have adopted a wireless charging method. However, actual customer bases have not frequently used such a method. This is due to the fact that wireless chargers have not been popularized, due to the inconvenience of slow charging speeds, as compared to a wired charging method. In order to improve such slow charging speeds, it is necessary to increase the charging power first. However, when charging power is increased, heat radiation is intensified, and the need to resist high set temperatures is not satisfied by set makers, obstructing the production or commercialization of wireless charging products.

Meanwhile, based on the Rx resonator, the causes of internal heat radiation differ, but the main causes may be divided into power loss caused by a coil, power loss caused by a magnetic body, and power loss of a power management IC (PMIC). In the case of the heat dissipation mechanism of the Rx resonator, heat generated by power loss of the coil may be transmitted to a heat dissipating sheet (graphite) through a magnetic material sheet, and the heat may be dissipated.

Therefore, it is necessary to develop a structure that not only relatively reduces heat generated by the coil to reduce a heat radiation, but that also efficiently dissipates the heat generated by the coil by utilizing neighboring equipment and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a coil module includes an insulation layer; a wireless power transfer (WPT) coil disposed on a first surface of the insulation layer; and a heat dissipation pattern disposed around the WPT coil on the first surface of the insulation layer or disposed on a second surface of the insulation layer opposite the first surface, wherein a width the heat dissipation pattern is narrower than a width of the WPT coil.

The width of the heat dissipation pattern may be less than or equal to five (5) times a skin depth of a conductor of the WPT coil.

The coil module may further include a dummy pattern disposed at an edge of the insulation layer and provided on one or both of the first surface and the second surface of the insulation layer, and the heat dissipation pattern may be connected to the dummy pattern.

In the coil module, the heat dissipation pattern may be disposed between the WPT coil and the dummy pattern.

In the coil module, the WPT coil may be disposed on an upper surface of the insulation layer, and the heat dissipation pattern may be disposed on a lower surface of the insulation layer.

In the coil module, the heat dissipation pattern may be disposed on the entire area of the lower surface of the insulation layer.

In the coil module, the heat dissipation pattern may include a first heat dissipation pattern having a bar shape disposed in a width direction of the insulation layer.

In the coil module, the heat dissipation pattern may include a second heat dissipation pattern having a bar shape disposed in a longitudinal direction of the insulation layer.

In the coil module, the heat dissipation pattern may include a third heat dissipation pattern having a bar shape disposed in a radial manner.

In the coil module, the heat dissipation pattern may have a bar shape disposed in at least two of a width direction of the insulation layer, a longitudinal direction of the insulation layer, and a radial direction of the insulation layer.

The coil module may further include a shielding sheet disposed to cover the WPT coil.

In the coil module, a thickness of the heat dissipation pattern may be less than or equal to a thickness of the WPT coil.

The coil module may further include a near-field communication (NFC) coil disposed on one or both of the first surface and the second surface of the insulation layer at an edge of the insulation layer.

In the coil module, a width of the heat dissipation pattern may be less than or equal to twenty-five (25) times a skin depth of a conductor of the NFC coil.

In another general aspect, a coil module includes an insulation layer; a near-field communication NFC coil disposed on at least one surface of the insulation layer; and a heat dissipation pattern disposed in an inner region of the NFC coil and disposed in an outer region of the NFC coil, wherein a width of the heat dissipation pattern is less than or equal to twenty-five (25) times a skin depth of a conductor of the NFC coil.

The coil module may further include a dummy pattern disposed at an edge of the insulation layer and provided on at least one surface of the insulation layer, and the heat dissipation pattern may be connected to the dummy pattern.

The coil module may further include a wireless power transfer (WPT) coil disposed on at least one surface of the insulation layer in the inner region of the NFC coil.

In the coil module, a width of the heat dissipation pattern may less than or equal to five (5) times a skin depth of a conductor of the WPT coil.

In another general aspect, a coil module includes: an insulation layer; a wireless power transfer (WPT) coil disposed one or both of a first surface of the insulation layer and a second surface of the insulation layer opposite the first surface; and a heat dissipation pattern disposed on one or both of the first surface of the insulation layer and the second surface of the insulation layer, and a width of the heat dissipation pattern is different than a width of the WPT coil.

The WPT coil may disposed on both the first surface of the insulation layer and the second surface of the insulation layer, and the heat dissipation pattern may be disposed on the first surface of the insulation layer around the WPT coil and disposed on the second surface of the insulation layer around the WPT coil.

The WPT coil may be disposed only on the first surface of the insulation layer, and the heat dissipation pattern may be disposed only on the second surface of the insulation layer.

The heat dissipation pattern may include a first dissipation pattern disposed in a first direction and a second dissipation pattern disposed in a second direction different from the first direction.

The coil module may include a dummy pattern disposed on one or both of the first surface of the insulation layer and the second surface of the insulation layer.

Other features and aspects will be apparent from the following detailed description, the drawings, and the claims.

### BRIEF DESCRIPTION OF DRAWINGS

FIG. 1 is an exploded perspective view illustrating a coil module according to an example.

FIG. 2 is a schematic plan view illustrating a coil module according to an example.

FIG. 3 is a schematic cross-sectional view illustrating a coil module according to an example.

FIG. 4 is an enlarged view of portion A in FIG. 2.

FIG. 5 is an enlarged view of portion B in FIG. 2.

FIG. 6 is an enlarged view of portion C in FIG. 2.

FIG. 7 is a schematic cross-sectional view illustrating a coil module according to an example.

FIG. 8 is a plan view illustrating a coil module according to an example.

FIG. 9 is a bottom view illustrating a coil module according to an example.

FIG. 10 is a schematic cross-sectional view illustrating a coil module according to an example.

FIG. 11 is a plan view illustrating a coil module according to an example.

FIG. 12 is a bottom view illustrating a coil module according to an example.

FIG. 13 is a plan view illustrating an example of a heat dissipation pattern of a coil module.

FIG. 14 is a plan view illustrating a coil module according to an example.

FIG. 15 is a bottom view illustrating a coil module according to an example.

FIG. 16 is a plan view illustrating a coil module according to an example.

FIG. 17 is a bottom view illustrating a coil module according to an example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Hereinafter, examples will be described with reference to the accompanying drawings. However, the examples may be modified to have various other forms, and the scope of the present disclosure is not limited to the examples described below. Further, examples are provided to more fully explain the present disclosure to those skilled in the art. Shape and size of the elements in the drawings may be exaggerated for clarity.

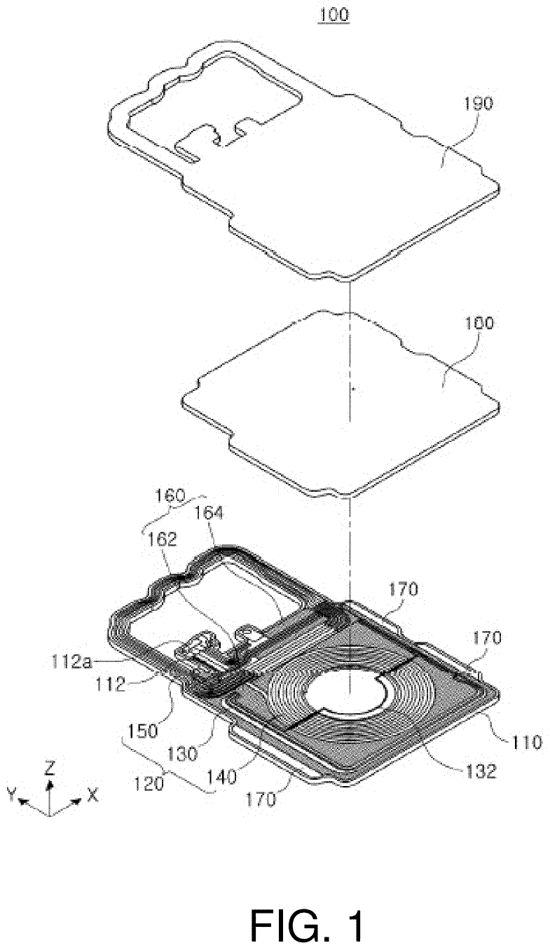

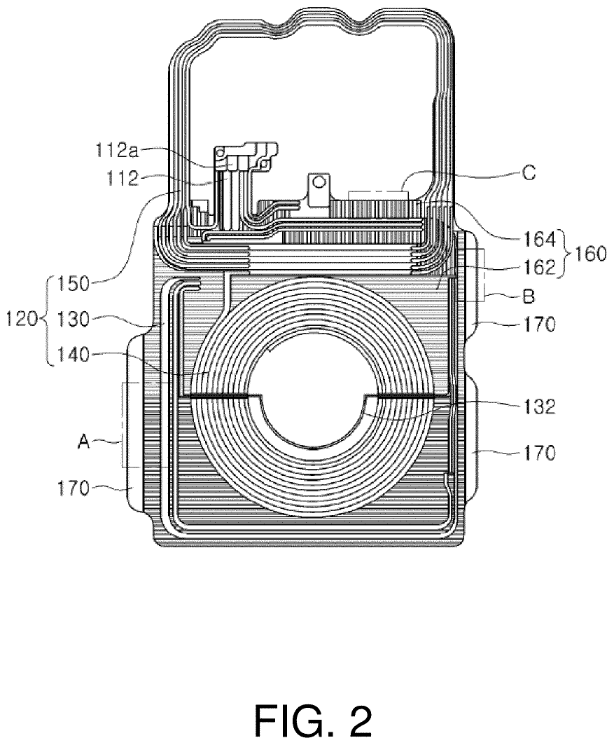

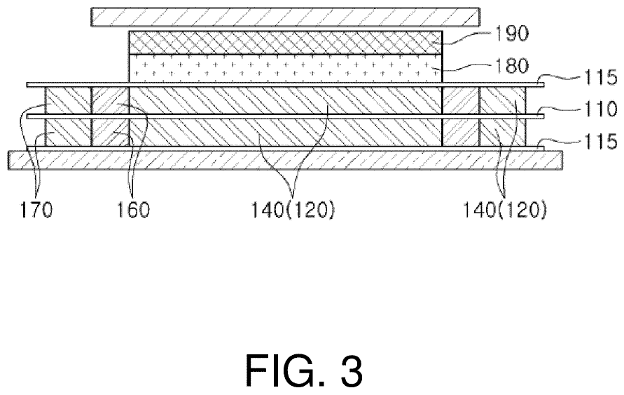

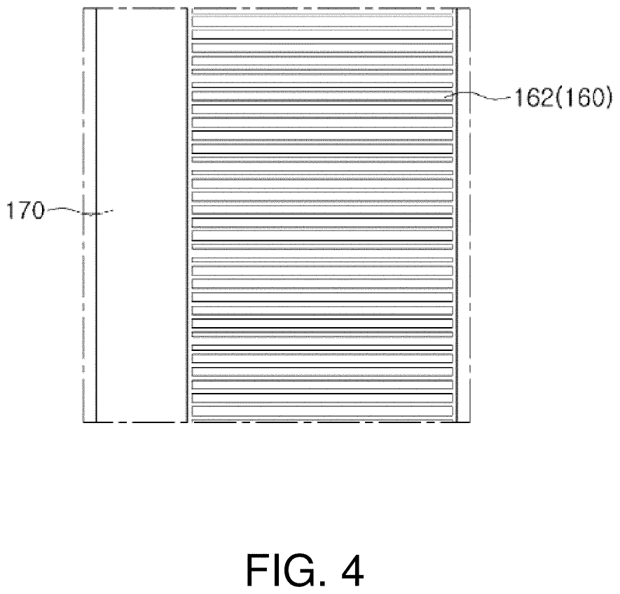

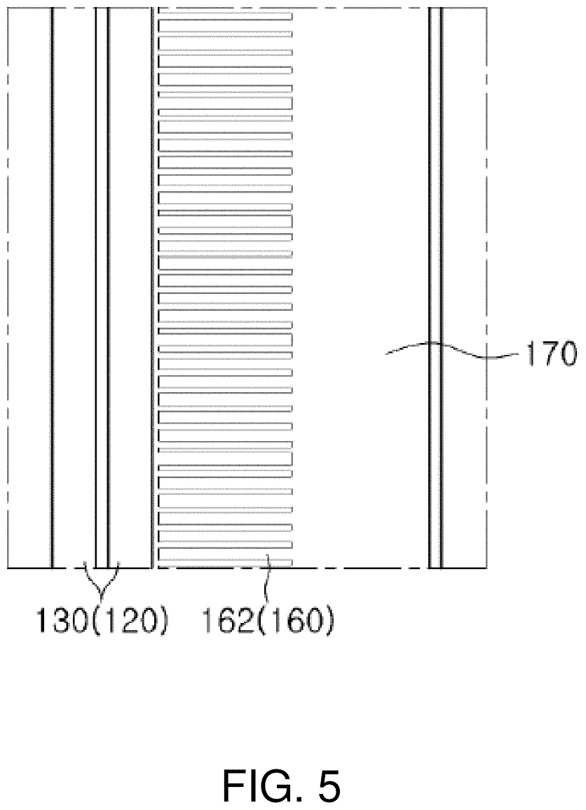

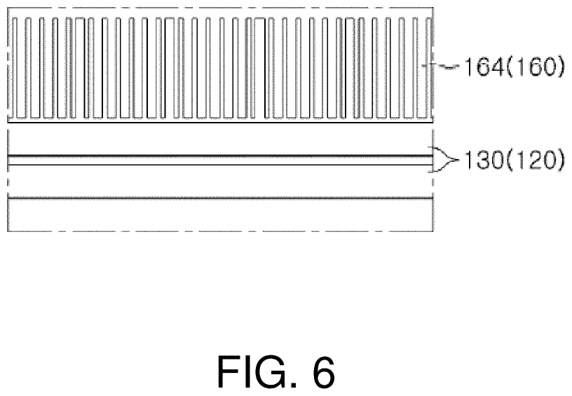

FIG. 1 is an exploded perspective view illustrating a coil module according to an example; FIG. 2 is a schematic plan view illustrating a coil module according to an example; FIG. 3 is a schematic cross-sectional view illustrating a coil module according to an example; FIG. 4 is an enlarged view of portion A in FIG. 2; FIG. 5 is an enlarged view of portion B in FIG. 2; and FIG. 6 is an enlarged view of portion C in FIG. 2.

Referring to FIGS. 1 to 6, a coil module 100 according may include an insulation layer 110, a cover layer 115, a coil portion 120, a heat dissipation pattern 160, a dummy pattern 170, a shielding sheet 180, and a protection film 190.

The insulation layer 110 may be formed of a hard material, for example. The insulation layer 110 may be a material having a heat resistance, a pressure resistance, and a flexibility, as a base material of which the coil portion 120 is formed. For example, the insulation layer 110 may be formed of a material containing an epoxy resin (for example, FR-3, FR-4, or the like). For example, the insulation layer 110 may be formed of multiple plies of paper with an epoxy resin adhesive incorporated therein, or may be formed by stacking multiple plies of glass fibers impregnated with an epoxy resin.

The insulation layer 110 may be, for example, an insulation layer of a flexible circuit board, and the coil portion 120 may be formed on both surfaces of the insulation layer 110.

The insulation layer 110 may be formed with an input/output terminal portion 112 extending for electrical connection to the outside. A plurality of connection terminals 112a may be formed in the input/output terminal portion 112, and the coil portion 120 may be connected to the connection terminal 112a. The number of the plurality of connection terminals 112a provided in the input/output terminal portion 112 may be variously changed.

The cover layer 115 may be disposed to cover the coil portion 120, the heat dissipation pattern 160, and the dummy pattern 170. The cover layer 115 may be formed of a transparent material, and may serve to protect the coil portion 120, the heat dissipation pattern 160, and the dummy pattern 170.

The coil portion 120 may be formed on both surfaces of the insulation layer 110, and may be connected to the input/output terminal portion 112. For example, the coil portion 120 may be a planar coil having a circular shape, an elliptical shape, or a polygonal shape, which may be wound clockwise or counterclockwise.

The coil portion 120 may include a near-field communication (NFC) coil 130 disposed along an outer periphery of the insulation layer 110, a wireless power transfer (WPT) coil 140 disposed in a central portion of the insulation layer 110, and a magnetic secure transmission (MST) coil 150 disposed in a position higher than (separated from in the Y direction) a position of the WPT coil 140.

The NFC coil 130 may be formed on both surfaces of the insulation layer 110, and the NFC coils 130 formed on both surfaces of the insulation layer 110 may be connected in series or in parallel. The NFC coil 130 may be connected to the input/output terminal portion 112, and may form an inner region with at least one turn in one direction along an edge of the insulation layer 110. The NFC coil 130 may have a first pattern 132 disposed to cross an inner region.

The first pattern 132 may be disposed to cross the WPT coil 140.

The WPT coil 140 may be also connected to the input/output terminal portion 112, and may be disposed in the central portion of the insulation layer 110. The WPT coil 140 may be disposed in an inner region of the NFC coil 130, and may have a substantially circular spiral shape. A shape of the WPT coil 140 may be variously changed by an elliptical spiral shape, a polygonal spiral shape, or the like.

The WPT coil 140 may be disposed on both surfaces of the insulation layer 110, and the WPT coil 140 disposed on both surfaces of the insulation layer 110 may be connected in series or in parallel. For example, the WPT coil 140 disposed on an upper surface of the insulation layer 110 and the WPT coil 140 disposed on a lower surface of the insulation layer 110 may be connected in parallel through a via (not illustrated).

The WPT coil 140 may have eleven (11) turns, a line width may be about 0.8 mm, and an interval between the WPT coils 140 may be about 0.1 mm. An inner diameter of the WPT coil 140 may be approximately 15 mm to 25 mm, and an outer diameter of the WPT coil 140 may be approximately 40 mm to 50 mm. The dimensions/configuration of the WPT coil 140 is not limited thereto, and the number of turns, a line width, an interval of a line width, a diameter, or the like of the WPT coil 140 may be modified.

The WPT coil 140 may perform multiple functions. For example, the WPT coil 140 may perform a function of transmitting power, and a function of wirelessly transmitting magnetic information. Specifically, the MST coil 150 and the WPT coil 140 may be connected to each other, to transmit MST information wirelessly.

The MST coils 150 may be formed on both surfaces of the insulation layer 110, and the MST coils 150 formed on both surfaces of the insulation layer 110 may be connected in series or in parallel. The MST coil 150 may be also connected to the input/output terminal portion 112, and may be disposed in an upper end portion of the insulation layer 110. The MST coil 150 may serve to transmit magnetic information wirelessly. The MST coil 150 may be disposed on a portion of the insulation layer 110 having a strip shape.

Since the NFC coil 130 has a frequency band higher than a frequency band of the WPT coil 140, the NFC coil 130 may be formed as a conductive pattern having a relatively fine line width. Since the WPT coil 140 uses a frequency band lower than a frequency band of the NFC coil 130, the WPT coil 140 may be formed inside of the NFC coil 130 as a conductive pattern having a line width wider than a line width of the NFC coil 130.

The MST coil 150 may be formed as a conductive pattern having the same line width as the WPT coil 140, as an embodiment. The present disclosure is not limited thereto, and the MST coil 150 may be formed to be narrower or wider than a line width of the WPT coil 140.

The heat dissipation patterns 160 may be formed on both surfaces of the insulation layer 110, and may be disposed around the WPT coil 140. A width of the heat dissipation pattern 160 may be narrower than a width of the WPT coil 140. Further, the heat dissipation pattern 160 may have a width equal to five (5) or less times a skin depth of a conductor used as the WPT coil 140.

The skin depth refers to a numerical value indicating a skin effect, and refers to a numerical value indicating how deep electric current penetrates to the depth depending on the relationship between the frequency and the metal component. Further, as frequency of a signal increases, phenomenon that electric current concentrates on a surface of a conductor may be known as a skin effect, and depth at which electric current flows may be known as a skin depth.

The skin depth may be defined by the following equation.

$$Skin Depth = {δ}_{5} = \sqrt{\frac{2 ρ}{2 π f {μ}_{0} {μ}_{R}}}$$

Where, ρ (ohm-meters) denotes a resistivity, f (Hertz) denotes a frequency, μ₀ denotes a permeability constant, and μ_{R} denotes a relative permeability.

When the heat dissipation pattern 160 has a width equal to five (5) or less times the skin depth of the conductor used as the WPT coil 140, an induced electric current may be applied to the heat dissipation pattern 160 to prevent occurrence of a magnetic field.

When an electric current is applied to the WPT coil 140, an induced electric current may flow through the heat dissipation pattern 160 disposed adjacent to the WPT coil 140 by electromagnetic induction. When the heat dissipation pattern 160 has a width equal to five (5) or less times the skin depth of the conductor used as the WPT coil 140, an induced electric current may be prevented from being applied to the heat dissipation pattern 160 by electromagnetic induction, or occurrence of a magnetic field due to an induced electric current flowing through the heat dissipation pattern 160 may be prevented.

A width of the heat dissipation pattern 160, a magnitude of an electric current applied to the WPT coil 140, a material of the heat dissipation pattern 160, and the like may be selected, such that loss of the wireless charging efficiency of the WPT coil 140 by the heat dissipation pattern 160 is 2% or less.

The heat dissipation pattern 160 may be formed of a conductive material such as copper.

The heat dissipation pattern 160 may include a first heat dissipation pattern 162 having a bar shape, disposed in a width direction (i.e., a sideways direction) of the insulation layer 110, and a second heat dissipation pattern 164 having a bar shape, disposed in a longitudinal direction (i.e., a lengthwise direction) of the insulation layer 110.

The first heat dissipation pattern 162 may be disposed around the WPT coil 140 and outside of the NFC coil 130, as illustrated in FIGS. 4 and 5; and the second heat dissipation pattern 164 may be disposed on the insulation layer 110 disposed in an inner region of the MST coil 150, as illustrated in FIG. 6.

Further, as illustrated in FIGS. 4 and 5, the first heat dissipation pattern 162 may be connected to the dummy pattern 170, which will be described later.

If a term for orientation is defined, a width direction refers to an X direction (i.e., a horizontal direction) in FIG. 1, a longitudinal direction refers to a Y direction (i.e., the vertical direction) in FIG. 1, and a thickness direction refers to a Z direction in FIG. 1.

The heat dissipation pattern 160 may be connected to the dummy pattern 170. For example, the heat dissipation pattern 160 may transmit heat generated from the WPT coil 140 to the dummy pattern 170. Therefore, heat generated from the WPT coil 140 may ultimately be transmitted to a case (not illustrated) of an electronic device (not illustrated).

The dummy pattern 170 may be disposed at the edge of the insulation layer 110, and may contact a case (not illustrated) of an electronic device (not illustrated). The dummy pattern 170 may be connected to a case formed of an aluminum material, and may transmit heat to the case. The dummy pattern 170 may be formed on both the upper and lower surfaces of the insulation layer 110. Further, the dummy pattern 170 may have a thickness equal to a thickness of the WPT coil 140. The dummy pattern 170 may be formed of a conductive material such as copper.

The shielding sheet 180 may serve to shield a magnetic field generated in the coil portion 120. The shielding sheet 180 has a size sufficient enough to cover the coil portion 120. The shielding sheet 180 may include a magnetic material sheet (not illustrated) and an adhesive layer (not illustrated). The magnetic material sheet may be composed of at least two relatively thin plates. For example, a magnetic material contained in the magnetic material sheet may be used as a magnetic path of a magnetic field generated by the coil portion 120, and may be provided for efficiently forming a magnetic path of a magnetic field. The magnetic material may be formed of a material that may be easily formed into a magnetic path, and materials having magnetic permeability such as ferrite, nanocrystal magnetic material, amorphous magnetic material, silicon steel, and the like, may be used.

The adhesive layer may be an adhesive material that is formed on at least one surface of the magnetic material sheet and may be a commonly used adhesive material, for example, a known resin composition, and may be formed of a material that physically bonds the magnetic material sheet or forms a chemical bond with a magnetic layer of the magnetic material sheet.

The protection film 190 may be disposed on or in a position higher (in a thickness direction) than a position of the shielding sheet 180, and may serve to prevent damage to the shielding sheet 180 and the coil portion 120. An adhesive layer (not illustrated) may be formed on a lower surface of the protection film 190.

As described above, since the heat dissipation pattern 160 connected to the dummy pattern 170 may be provided as a heat transfer path in which heat generated from the WPT coil 140 is transmitted to the outside, heat dissipating characteristics may be improved.

Hereinafter, other examples will be described with reference to the drawings. In the meantime, the same components as those described above will be denoted by the same reference numerals, and will not be described in detail with reference to the drawings.

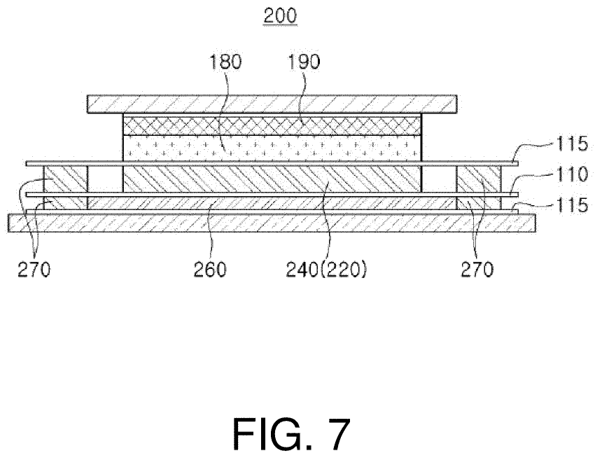

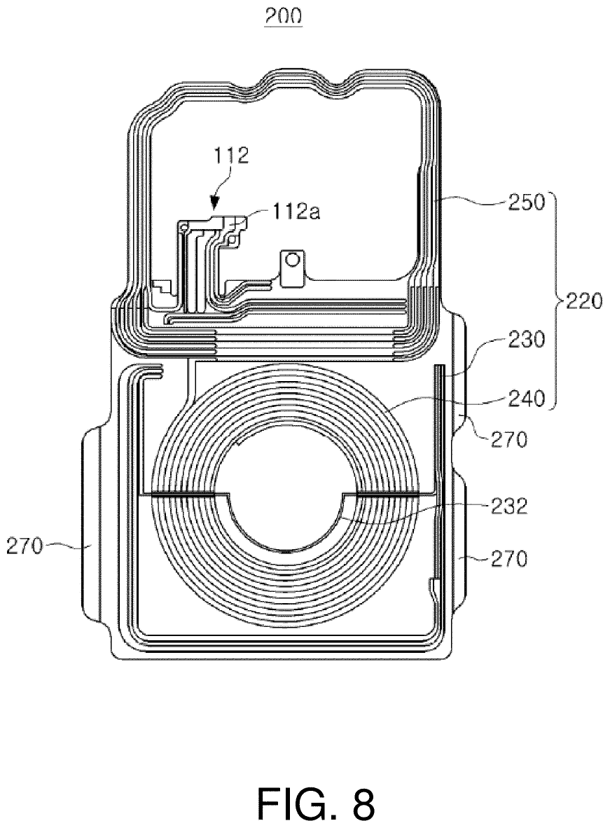

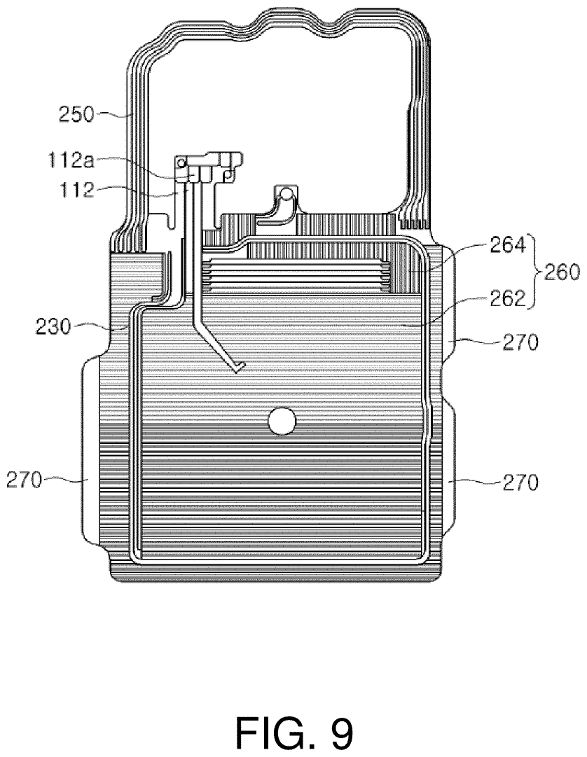

FIG. 7 is a schematic cross-sectional view illustrating a coil module according to an example; FIG. 8 is a plan view illustrating a coil module according to an example; and FIG. 9 is a bottom view illustrating a coil module according to an example.

Referring to FIGS. 7 to 9, a coil module 200 may include an insulation layer 110, a cover layer 115, a coil portion 220, a heat dissipation pattern 260, a dummy pattern 270, a shielding sheet 180, and a protection film 190.

Since the insulation layer 110, the cover layer 115, the shielding sheet 180, and the protection film 190 are the same as those described above, a detailed description thereof will be omitted.

The coil portion 220 may be formed on both surfaces of the insulation layer 110, and may be connected to an input/output terminal part 112. For example, the coil portion 220 may be a planar coil having a circular shape, an elliptical shape, or a polygonal shape, which may be wound clockwise or counterclockwise.

The coil portion 220 may include an NFC coil 230 disposed along an outer periphery of the insulation layer 110, a WPT coil 240 disposed in a central portion of the insulation layer 110, and an MST coil 250 disposed in a position higher than a position of the WPT coil 240.

The NFC coil 230 may be formed on both surfaces of the insulation layer 110, and the NFC coils 230 formed on both surfaces of the insulation layer 110 may be connected in series or in parallel. The NFC coil 230 may be connected to the input/output terminal portion 112, and may form an inner region with at least one turn in one direction along an edge of the insulation layer 110. The NFC coil 230 may have a first pattern 232 disposed to cross an inner region. The first pattern 232 may be disposed to cross the WPT coil 240.

The WPT coil 240 may be also connected to the input/output terminal portion 112, and may be disposed in the central portion of the insulation layer 110. The WPT coil 240 may be disposed in an inner region of the NFC coil 230, and may have a substantially circular spiral shape. A shape of the WPT coil 240 may be variously changed by an elliptical spiral shape, a polygonal spiral shape, or the like.

The WPT coil 240 may be formed only on an upper surface of the insulation layer 110.

The WPT coil 240 may have eleven (11) turns, a line width may be about 0.8 mm, and an interval between the WPT coils 240 may be about 0.1 mm. An inner diameter of the WPT coil 240 may be approximately 15 mm to 25 mm, and an outer diameter of the WPT coil 240 may be approximately 40 mm to 50 mm. The dimensions/configuration of the WPT coil 240 is not limited thereto, and the number of turns, a line width, an interval of a line width, a diameter, or the like of the WPT coil 240 may be variously changed.

The WPT coil 240 may perform multiple functions. For example, the WPT coil 240 may perform a function of transmitting power, and a function of wirelessly transmitting magnetic information.

An empty space may be disposed between the dummy pattern 270 and the WPT coil 240 formed on the upper surface of the insulation layer 110.

The MST coil 250 may be formed on both surfaces of the insulation layer 110, and the MST coils 250 formed on both surfaces of the insulation layer 110 may be connected in series or in parallel. The MST coil 250 may be also connected to the input/output terminal portion 112, and may be disposed in an upper end portion of the insulation layer 110. The MST coil 250 may transmit magnetic information wirelessly. The MST coil 250 may be disposed on a portion of the insulation layer 110 having a strip shape.

Since the NFC coil 230 has a frequency band higher than a frequency band of the WPT coil 240, the NFC coil 230 may be formed as a conductive pattern having a relatively fine line width. Since the WPT coil 240 uses a frequency band lower than a frequency band of the NFC coil 230, the WPT coil 240 may be formed inside of the NFC coil 230 as a conductive pattern having a line width wider than a line width of the NFC coil 230.

The MST coil 250 may be formed as a conductive pattern having the same line width as the WPT coil 240. The MST coil 250 may be formed to be narrower or wider than a line width of the WPT coil 240.

The heat dissipation pattern 260 may be formed only on the lower surface of the insulation layer 110. A width of the heat dissipation pattern 260 may be narrower than a width of the WPT coil 240. Further, the heat dissipation pattern 260 has a width equal to five (5) or less times a skin depth of a conductor used as the WPT coil 240. A width of the heat dissipation pattern 260, a magnitude of an electric current applied to the WPT coil 240, a material of the heat dissipation pattern 260, and the like may be selected, such that loss of the wireless charging efficiency of the WPT coil 240 by the heat dissipation pattern 260 is 2% or less.

The heat dissipation pattern 260 may be formed of a conductive material such as copper.

The heat dissipation pattern 260 may include a first heat dissipation pattern 262 having a bar shape, disposed in a width direction (i.e., a sideways direction) of the insulation layer 110, and a second heat dissipation pattern 264 having a bar shape, disposed in a longitudinal direction (i.e., a lengthwise direction) of the insulation layer 110.

The first heat dissipation pattern 262 may be formed on a lower surface of the insulation layer 110, and may be disposed to cross the WPT coil 240 disposed on an upper surface. The first heat dissipation pattern 262 may be disposed around the NFC coil 230, and may be connected to the dummy pattern 270.

The second heat dissipation pattern 264 may be formed on a lower surface of the insulation layer 110, and may be disposed on an upper end portion of the first heat dissipation pattern 262.

The heat dissipation pattern 260 may have a thickness that is thinner than a thickness of the WPT coil 240.

The heat dissipation pattern 260 may be connected to the dummy pattern 270. For example, the heat dissipation pattern 260 may serve to transmit heat generated from the WPT coil 240 to the dummy pattern 270. Therefore, heat generated from the WPT coil 240 may ultimately be transmitted to a case (not illustrated) of an electronic device (not illustrated).

The heat dissipation pattern 260 may have a thickness that is thinner than a thickness of the coil portion 220.

The dummy pattern 270 may be disposed at the edge of the insulation layer 110, and may contact a case (not illustrated) of an electronic device (not illustrated). The dummy pattern 270 may be connected to a case formed of an aluminum material, and may transmit heat to the case. The dummy pattern 270 may be formed on both the upper and lower surfaces of the insulation layer 110. Further, the dummy pattern 270 may have a thickness equal to a thickness of the WPT coil 240. For example, a thickness of the dummy pattern 270 formed on an upper surface of the insulation layer 110 may be formed thicker than a thickness of the dummy pattern 270 formed on a lower surface of the insulation layer 110. Meanwhile, the dummy pattern 270 may be formed of a conductive material such as copper.

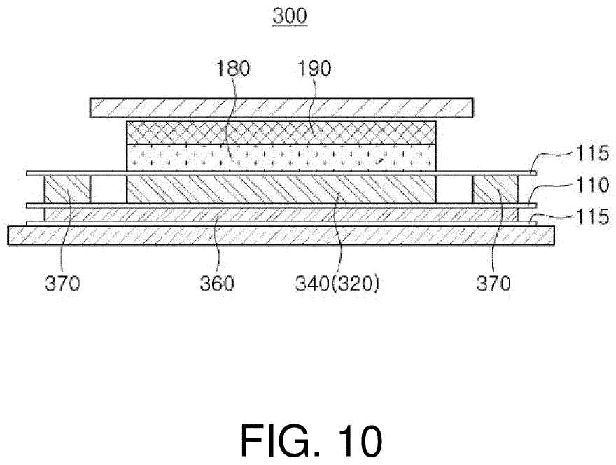

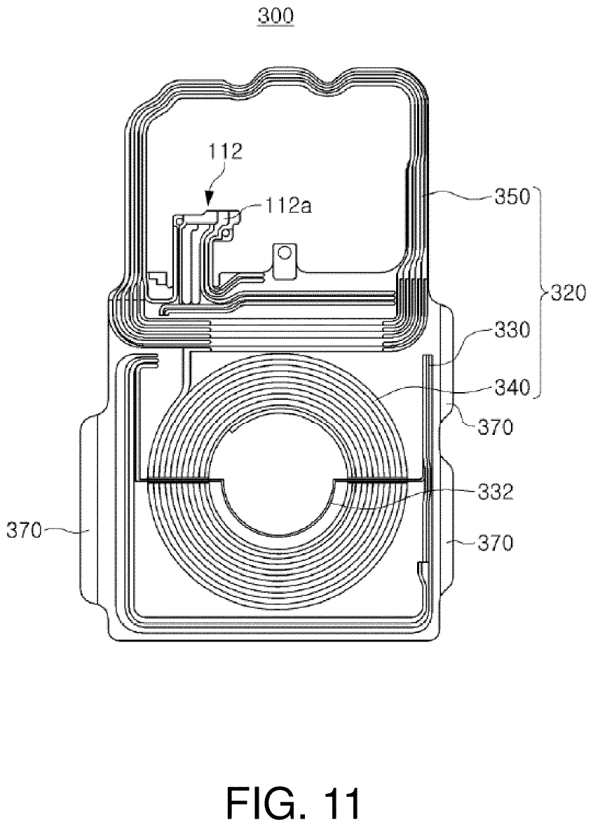

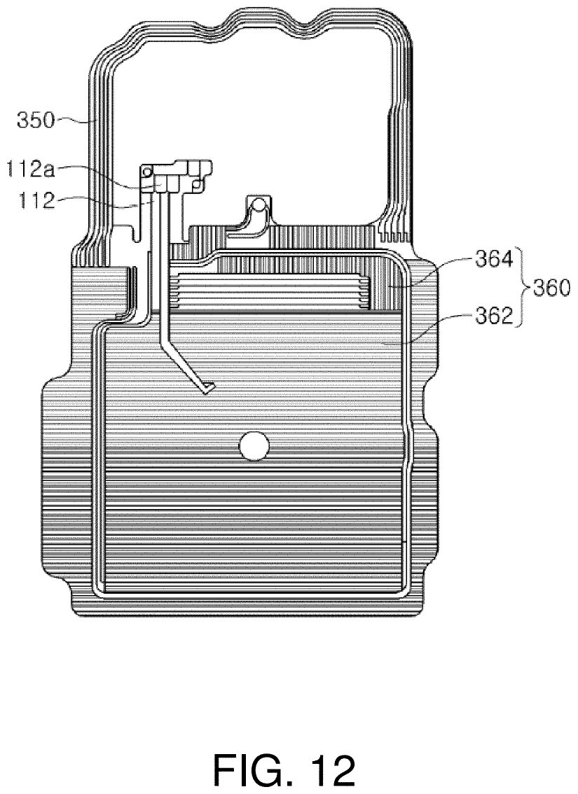

FIG. 10 is a schematic cross-sectional view illustrating a coil module according to an example; FIG. 11 is a plan view illustrating a coil module according to an example; and FIG. 12 is a bottom view illustrating a coil module according to an example.

Referring to FIGS. 10 to 12, a coil module 300 may include an insulation layer 110, a cover layer 115, a coil portion 320, a heat dissipation pattern 360, a shielding sheet 180, and a protection film 190.

The coil portion 320 may be formed on both surfaces of the insulation layer 110, and may be connected to the input/output terminal portion 112. For example, the coil portion 320 may be a planar coil having a circular shape, an elliptical shape, or a polygonal shape, which may be wound clockwise or counterclockwise.

The coil portion 320 may include an NFC coil 330 disposed along an outer periphery of the insulation layer 110, a WPT coil 340 disposed in a central portion of the insulation layer 110, and an MST coil 350 disposed in a position higher than a position of the WPT coil 340.

The NFC coil 330 may be formed on both surfaces of the insulation layer 110, and the NFC coils 330 formed on both surfaces of the insulation layer 110 may be connected in series or in parallel. The NFC coil 330 may be connected to the input/output terminal portion 112, and may form an inner region with at least one turn in one direction along an edge of the insulation layer 110. The NFC coil 330 may have a first pattern 332 disposed to cross an inner region. The first pattern 332 may be disposed to cross the WPT coil 340.

The WPT coil 340 may be also connected to the input/output terminal portion 112, and may be disposed in the central portion of the insulation layer 110. The WPT coil 340 may be disposed in an inner region of the NFC coil 330, and may have a substantially circular spiral shape. A shape of the WPT coil 340 may be variously changed by an elliptical spiral shape, a polygonal spiral shape, or the like.

For example, the WPT coil 340 may be formed only on an upper surface of the insulation layer 110.

The WPT coil 340 may have eleven (11) turns, a line width may be about 0.8 mm, and an interval between the WPT coils 340 may be about 0.1 mm. An inner diameter of the WPT coil 340 may be approximately 15 mm to 25 mm, and an outer diameter of the WPT coil 340 may be approximately 40 mm to 50 mm. The dimensions/configuration of the WPT coil 340 is not limited thereto, and the number of turns, a line width, an interval of a line width, a diameter, or the like of the WPT coil 340 may be variously changed.

The WPT coil 340 may perform multiple functions. For example, the WPT coil 340 may perform a function of transmitting power, and a function of wirelessly transmitting magnetic information.

An empty space may be disposed between the dummy pattern 370 and the WPT coil 340 formed on the upper surface of the insulation layer 110.

The MST coil 350 may be formed on both surfaces of the insulation layer 110, and the MST coils 350 formed on both surfaces of the insulation layer 110 may be connected in series or in parallel. The MST coil 350 may be also connected to the input/output terminal portion 112, and may be disposed in an upper end portion of the insulation layer 110. The MST coil 350 may transmit magnetic information wirelessly. The MST coil 350 may be disposed on a portion of the insulation layer 110 having a strip shape.

Since the NFC coil 330 has a frequency band higher than a frequency band of the WPT coil 340, the NFC coil 330 may be formed as a conductive pattern having a relatively fine line width. Since the WPT coil 340 uses a frequency band lower than a frequency band of the NFC coil 330, the WPT coil 340 may be formed inside of the NFC coil 330 as a conductive pattern having a line width wider than a line width of the NFC coil 330.

The MST coil 350 may be formed as a conductive pattern having the same line width as the WPT coil 340. The MST coil 350 may be formed to be narrower or wider than a line width of the WPT coil 340.

The heat dissipation pattern 360 may be formed only on the lower surface of the insulation layer 110. A width of the heat dissipation pattern 360 may be narrower than a width of the WPT coil 340. Further, the heat dissipation pattern 360 has a width equal to five (5) or less times a skin depth of a conductor used as the WPT coil 340. A width of the heat dissipation pattern 360, a magnitude of an electric current applied to the WPT coil 340, a material of the heat dissipation pattern 360, and the like may be selected, such that loss of the wireless charging efficiency of the WPT coil 340 by the heat dissipation pattern 360 is 2% or less.

The heat dissipation pattern 360 may be formed of a conductive material such as copper.

The heat dissipation pattern 360 may include a first heat dissipation pattern 362 having a bar shape, disposed in a width direction (i.e., a sideways direction) of the insulation layer 110, and a second heat dissipation pattern 364 having a bar shape, disposed in a longitudinal direction (i.e., a lengthwise direction) of the insulation layer 110.

The first heat dissipation pattern 362 may be formed on a lower surface of the insulation layer 110, and may be disposed to cross the WPT coil 340 disposed on an upper surface. The first heat dissipation pattern 362 may be disposed around the NFC coil 330, and may be extended to be disposed in a position lower than a position of the dummy pattern 370. The dummy pattern 370 may be formed only on the upper surface of the insulation layer 110, and the dummy pattern 370 may be not formed on the lower surface of the insulation layer 110. The second heat dissipation pattern 364 may be formed on the lower surface of the insulation layer 110, and may be disposed on an upper end portion of the first heat dissipation pattern 362.

The heat dissipation pattern 360 may have a thickness that is thinner than a thickness of the WPT coil 340.

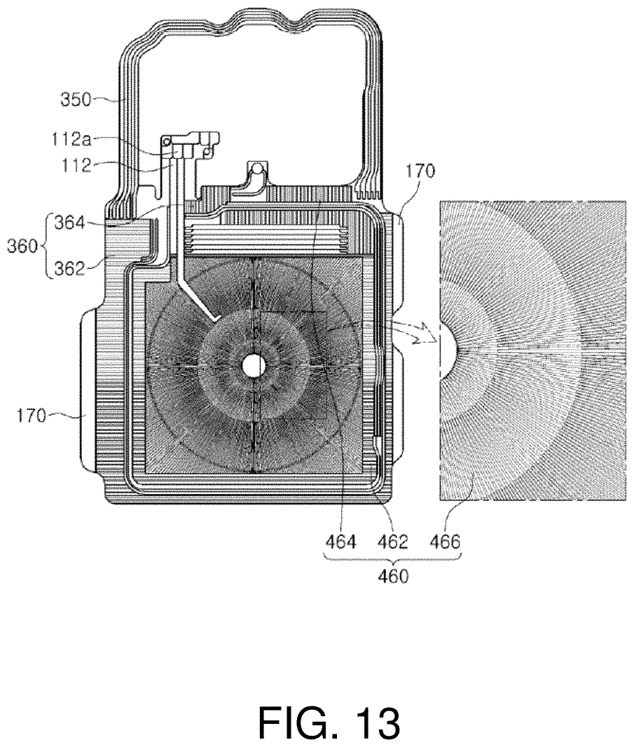

FIG. 13 is a plan view illustrating an example of a heat dissipation pattern of a coil module.

Referring to FIG. 13, the heat dissipation pattern 460 may include a first heat dissipation pattern 462 having a bar shape, disposed in a width direction (i.e., a sideways direction) of the insulation layer 110, a second heat dissipation pattern 464 having a bar shape, disposed in a longitudinal direction (i.e., a lengthwise direction) of the insulation layer 110, and a third heat dissipation pattern 466 having a bar shape disposed in a radial manner.

The third heat dissipation pattern 466 may be disposed in a position lower than a position of the WPT coil 340 (see FIG. 10).

The first heat dissipation pattern 462 may be connected to the dummy pattern 170.

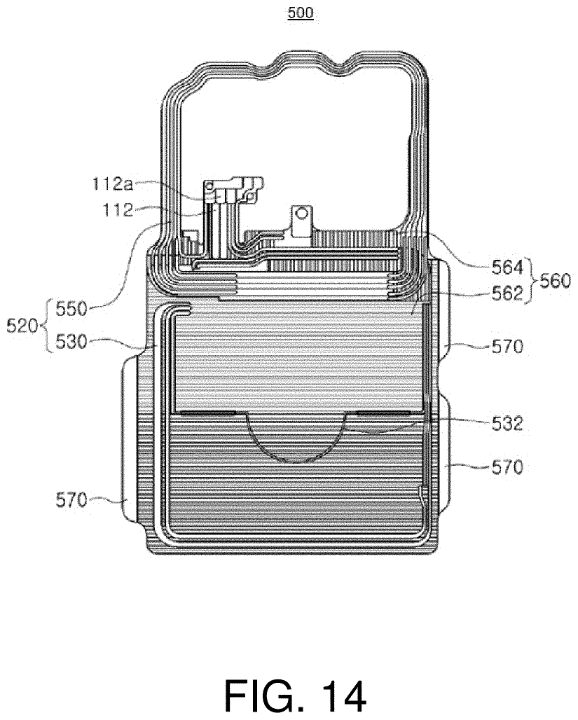

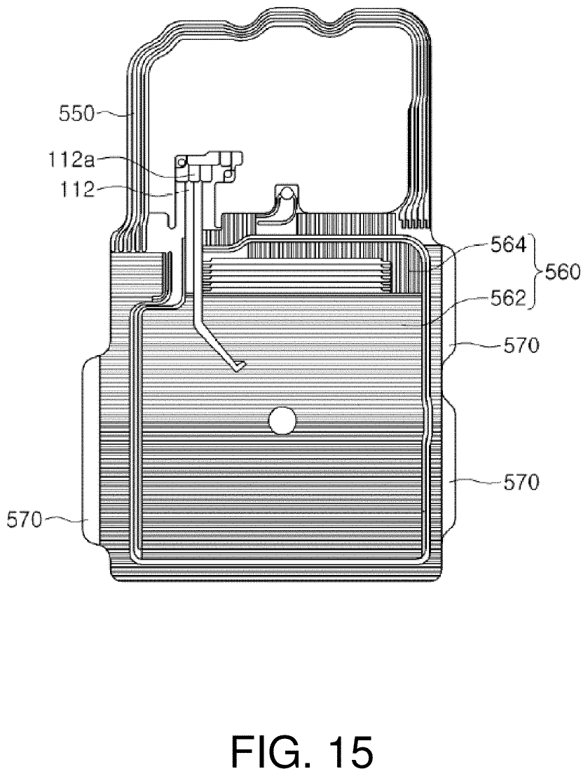

FIG. 14 is a plan view illustrating a coil module according to an example; and FIG. 15 is a bottom view illustrating a coil module according to an example.

Referring to FIGS. 14 and 15, a coil module 500 may include an insulation layer 110 (see FIG. 3), a cover layer 115 (see FIG. 3), a coil portion 520, a heat dissipation pattern 560, a dummy pattern 570, a shielding sheet 180 (see FIG. 1), and a protection film 190 (see FIG. 1).

Since the insulation layer 110, the cover layer 115, the shielding sheet 180, and the protection film 190 are substantially the same as the components of the coil module 100 illustrated in FIG. 1, a detailed description thereof will be omitted.

The coil portion 520 may be formed on both surfaces of the insulation layer 110, and may be connected to the input/output terminal portion 112. For example, the coil portion 520 may be a planar coil having a circular shape, an elliptical shape, or a polygonal shape, which may be wound clockwise or counterclockwise.

The coil portion 520 may include an NFC coil 530 disposed along an outer periphery of the insulation layer 110, and an MST coil 550 disposed at an upper end portion of the insulation layer 110 such that a portion of the MST coil 550 overlaps the NFC coil 530.

The NFC coils 530 may be formed on both surfaces of the insulation layer 110, and the NFC coils 530 formed on both surfaces of the insulation layer 110 may be connected in series or in parallel. The NFC coil 530 may be connected to the input/output terminal portion 112, and may form an inner region with at least one turn in one direction along an edge of the insulation layer 110. The NFC coil 530 may have a first pattern 532 disposed to cross an inner region. The first pattern 532 may be disposed to cross the central portion of the inner region formed by the NFC coil 530.

The MST coils 550 may be formed on both surfaces of the insulation layer 110, and the MST coils 550 formed on both surfaces of the insulation layer 110 may be connected in series or in parallel. The MST coil 550 may be also connected to the input/output terminal portion 112, and may be disposed in an upper end portion of the insulation layer 110. The MST coil 550 may transmit magnetic information wirelessly. The MST coil 550 may be disposed on a portion of the insulation layer 110 having a strip shape.

A WPT coil may be not provided in the coil portion 520. A heat dissipation pattern 560 may be formed in an inner region of the NFC coil 530 in which no WPT coil is formed.

The heat dissipation pattern 560 may be formed on both surfaces of the insulation layer 110, and may be disposed around the NFC coil 530. Further, the heat dissipation pattern 560 may have a width equal to twenty-five (25) or less times a skin depth of a conductor used as the NFC coil 530.

The skin depth refers to a numerical value indicating a skin effect, and refers to a numerical value indicating how deep electric current penetrates to the depth depending on the relationship between the frequency and the metal component. Further, as frequency of a signal increases, phenomenon that electric current concentrates on a surface of a conductor may be known as a skin effect, and depth at which electric current flows may be known as a skin depth.

The skin depth may be defined by the following equation.

$$Skin Depth = {δ}_{5} = \sqrt{\frac{2 ρ}{2 π f {μ}_{0} {μ}_{R}}}$$

Where, ρ (ohm-meters) denotes a resistivity, f (Hertz) denotes a frequency, μ₀ denotes a permeability constant, and μ_{R} denotes a relative permeability.

When the heat dissipation pattern 560 has a width equal to twenty-five (25) or less times the skin depth of the conductor used as the NFC coil 530, an induced electric current may be applied to the heat dissipation pattern 560 to prevent occurrence of a magnetic field.

When an electric current is applied to the NFC coil 530, an induced electric current may flow through the heat dissipation pattern 560 disposed adjacent to the NFC coil 530 by electromagnetic induction. When the heat dissipation pattern 560 has a width equal to twenty-five (25) or less times the skin depth of the conductor used as the NFC coil 530, an induced electric current may be prevented from being applied to the heat dissipation pattern 560 by electromagnetic induction, or occurrence of a magnetic field due to an induced electric current flowing through the heat dissipation pattern 560 may be prevented.

The heat dissipation pattern 560 may be formed of a conductive material such as copper.

The heat dissipation pattern 560 may include a first heat dissipation pattern 562 having a bar shape, disposed in a width direction (i.e., a sideways direction) of the insulation layer 110, and a second heat dissipation pattern 564 having a bar shape, disposed in a longitudinal direction (i.e., a lengthwise direction) of the insulation layer 110.

The heat dissipation pattern 560 may be connected to the dummy pattern 570. For example, the heat dissipation pattern 560 may transmit heat generated from the NFC coil 530 to the dummy pattern 570. Therefore, heat generated from the NFC coil 530 may ultimately be transmitted to a case (not illustrated) of an electronic device (not illustrated).

The dummy pattern 570 may be disposed at the edge of the insulation layer 110, and may contact a case (not illustrated) of an electronic device (not illustrated). The dummy pattern 570 may be connected to a case formed of an aluminum material, and may transmit heat to the case. The dummy pattern 570 may be formed on both the upper surface and the lower surface of the insulation layer 110. Further, the dummy pattern 570 may have a thickness equal to a thickness of the NFC coil 530. The dummy pattern 570 may be formed of a conductive material such as copper.

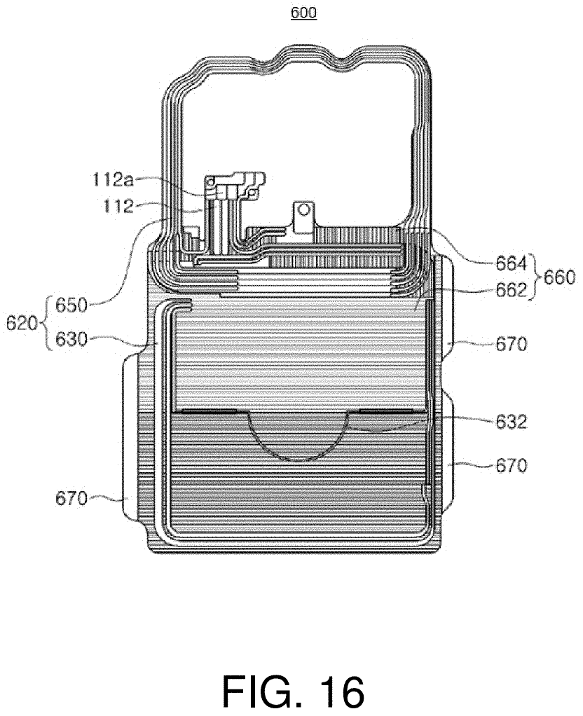

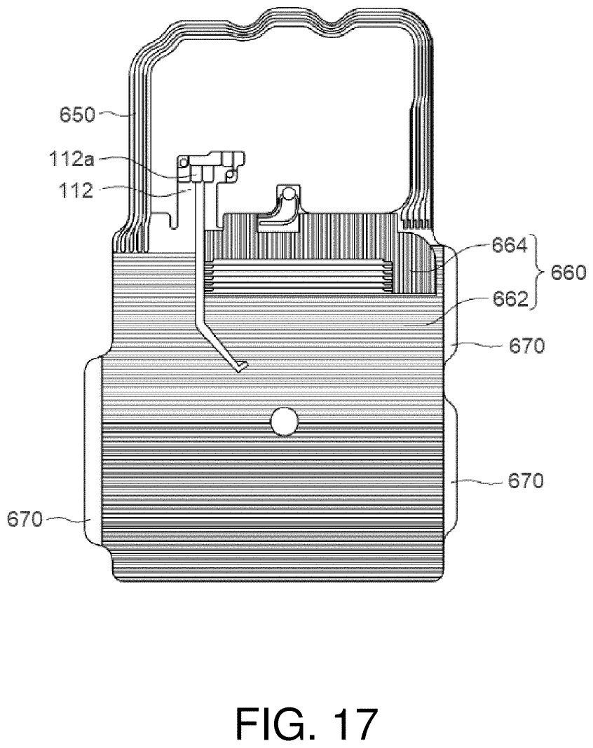

FIG. 16 is a plan view illustrating a coil module according to an example; and FIG. 17 is a bottom view illustrating a coil module according to an example

Referring to FIGS. 16 and 17, a coil module 600 may include an insulation layer 110 (see FIG. 3), a cover layer 115 (see FIG. 3), a coil portion 620, a heat dissipation pattern 660, a dummy pattern 670, a shielding sheet 180 (see FIG. 1), and a protection film 190 (see FIG. 1).

Since the insulation layer 110, the cover layer 115, the shielding sheet 180 and the protection film 190 are substantially the same as the constituent elements of the coil module 100 illustrated in FIG. 1, a detailed description thereof will be omitted.

The coil portion 620 may be formed on both surfaces of the insulation layer 110, and may be connected to the input/output terminal portion 112. For example, the coil portion 620 may be a planar coil having a circular shape, an elliptical shape, or a polygonal shape, which may be wound clockwise or counterclockwise.

The coil portion 620 may include an NFC coil 630 disposed along an outer periphery of the insulation layer 110, and an MST coil 650 disposed at an upper end portion of the insulation layer 110 such that a portion of the MST coil 650 overlaps the NFC coil 630.

The NFC coils 630 may be formed on one surface of the insulation layer 110. The NFC coil 630 may be connected to the input/output terminal portion 112, and may form an inner region with at least one turn in one direction along an edge of the insulation layer 110. The NFC coil 630 may include a first pattern 632 disposed to cross the inner region. The first pattern 632 may be disposed to cross the central portion of the inner region formed by the NFC coil 630.

The MST coil 650 may be formed on both surfaces of the insulation layer 110, and the MST coils 650 formed on both surfaces of the insulation layer 110 may be connected in series or in parallel. The MST coil 650 may be also connected to the input/output terminal portion 112, and may be disposed in an upper end portion of the insulation layer 110. The MST coil 650 may transmit magnetic information wirelessly. The MST coil 650 may be disposed on a portion of the insulation layer 110 having a strip shape.

A WPT coil may be not provided in the coil portion 620. The heat dissipation pattern 660 may be formed in an inner region of the NFC coil 630 in which no WPT coil is formed.

The heat dissipation pattern 660 may be formed on both surfaces of the insulation layer 110. The heat dissipation pattern 660 disposed on the upper surface of the insulation layer 110 may be disposed around the NFC coil 630, and the heat dissipation pattern 660 disposed on the lower surface of the insulation layer 110 may be disposed on the NFC coil 630. Further, the heat dissipation pattern 660 has a width equal to twenty-five (25) or less times a skin depth of a conductor used as the NFC coil 630.

When the heat dissipation pattern 660 has a width equal to twenty-five (25) or less times the skin depth of the conductor used as the NFC coil 630, an induced electric current may be applied to the heat dissipation pattern 660 to prevent occurrence of a magnetic field.

When an electric current may be applied to the NFC coil 630, an induced current may flow through the heat dissipation pattern 660 disposed adjacent to the NFC coil 630 by electromagnetic induction. When the heat dissipation pattern 660 has a width equal to twenty-five (25) or less times the skin depth of the conductor used as the NFC coil 630, an induced electric current may be prevented from being applied to the heat dissipation pattern 660 by electromagnetic induction, or occurrence of a magnetic field due to an induced electric current flowing through the heat dissipation pattern 660 may be prevented.

The heat dissipation pattern 660 may be formed of a conductive material such as copper.

The heat dissipation pattern 660 may include a first heat dissipation pattern 662 having a bar shape, disposed in a width direction (i.e., a sideways direction) of the insulation layer 110, and a second heat dissipation pattern 664 having a bar shape, disposed in a longitudinal direction (i.e., a lengthwise direction) of the insulation layer 110.

The heat dissipation pattern 660 may be connected to the dummy pattern 670. For example, the heat dissipation pattern 660 may transmit heat generated from the NFC coil 630 to the dummy pattern 670. Therefore, heat generated from the NFC coil 630 may ultimately be transmitted to a case (not illustrated) of an electronic device (not illustrated).

The dummy pattern 670 may be disposed at the edge of the insulation layer 110, and may contact a case (not illustrated) of an electronic device (not illustrated). The dummy pattern 670 may be connected to a case formed of an aluminum material, and may transmit heat to the case. The dummy pattern 670 may be formed on both the upper surface and the lower surface of the insulation layer 110. Further, the dummy pattern 670 may have a thickness equal to a thickness of the NFC coil 630. The dummy pattern 670 may be formed of a conductive material such as copper.

According to the examples, the heat radiation characteristic may be improved.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil module comprising:
an insulation layer;
a wireless power transfer (WPT) coil disposed on a first surface of the insulation layer; and
a heat dissipation pattern disposed around the WPT coil on the first surface of the insulation layer or disposed on a second surface of the insulation layer opposite the first surface,
wherein a width of the heat dissipation pattern is narrower than a width of the WPT coil.

2. The coil module according to claim 1, wherein the width of the heat dissipation pattern is less than or equal to five (5) times a skin depth of a conductor of the WPT coil.

3. The coil module according to claim 1, further comprising a dummy pattern disposed at an edge of the insulation layer and provided on one or both of the first surface and the second surface of the insulation layer,
wherein the heat dissipation pattern is connected to the dummy pattern.

4. The coil module according to claim 3, wherein the heat dissipation pattern is disposed between the WPT coil and the dummy pattern.

5. The coil module according to claim 3, wherein the WPT coil is disposed on an upper surface of the insulation layer, and the heat dissipation pattern is disposed on a lower surface of the insulation layer.

6. The coil module according to claim 5, wherein the heat dissipation pattern is disposed on the entire area of the lower surface of the insulation layer.

7. The coil module according to claim 1, wherein the heat dissipation pattern comprises a first heat dissipation pattern having a bar shape disposed in a width direction of the insulation layer.

8. The coil module according to claim 1, wherein the heat dissipation pattern comprises a second heat dissipation pattern having a bar shape disposed in a longitudinal direction of the insulation layer.

9. The coil module according to claim 1, wherein the heat dissipation pattern comprises a third heat dissipation pattern having a bar shape disposed in a radial manner.

10. The coil module according to claim 1, wherein the heat dissipation pattern has a bar shape disposed in at least two of a width direction of the insulation layer, a longitudinal direction of the insulation layer, and a radial direction of the insulation layer.

11. The coil module according to claim 1, further comprising a shielding sheet disposed to cover the WPT coil.

12. The coil module according to claim 1, wherein a thickness of the heat dissipation pattern is less than or equal to a thickness of the WPT coil.

13. The coil module according to claim 1, further comprising a near-field communication (NFC) coil disposed on one or both of the first surface and the second surface of the insulation layer at an edge of the insulation layer.

14. The coil module according to claim 13, wherein the width of the heat dissipation pattern is less than or equal to twenty-five (25) times a skin depth of a conductor of the NFC coil.

15. A coil module comprising:
an insulation layer;
a near-field communication (NFC) coil disposed on at least one surface of the insulation layer; and
a heat dissipation pattern disposed in an inner region of the NFC coil and disposed in an outer region of the NFC coil,
wherein a width of the heat dissipation pattern is less than or equal to twenty-five (25) times a skin depth of a conductor of the NFC coil.

16. The coil module according to claim 15, further comprising a dummy pattern disposed at an edge of the insulation layer on at least one surface of the insulation layer,
wherein the heat dissipation pattern is connected to the dummy pattern.

17. The coil module according to claim 14, further comprising a wireless power transfer (WPT) coil disposed on at least one surface of the insulation layer in the inner region of the NFC coil.

18. The coil module according to claim 17, wherein the width of the heat dissipation pattern is less than or equal to five (5) times a skin depth of a conductor of the WPT coil.

19. A coil module comprising:
an insulation layer;
a wireless power transfer (WPT) coil disposed one or both of a first surface of the insulation layer and a second surface of the insulation layer opposite the first surface; and
a heat dissipation pattern disposed on one or both of the first surface of the insulation layer and the second surface of the insulation layer,
wherein a width of the heat dissipation pattern is different than a width of the WPT coil.

20. The coil module of claim 19, wherein the WPT coil is disposed on both the first surface of the insulation layer and the second surface of the insulation layer, and the heat dissipation pattern is disposed on the first surface of the insulation layer around the WPT coil and disposed on the second surface of the insulation layer around the WPT coil.
